(19) United States
(12) Patent Application Publication
(10) Pub. No.: US 2007/0124376 A1
(43) Pub. Date: May 31, 2007

(54) Messaging Architecture

(75) Inventor: Thomas Ralph Edward Greenwell, Herts (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Symbian Limited, London (GB)

(21) Appl. No.: 11/531,524

(22) Filed: Sep. 13, 2006

Related U.S. Application Data
(63) Continuation of application No. 09/673,161, filed on Oct. 11, 2000.

(30) Foreign Application Priority Data
Feb. 11, 1999 (GB) 9903032.2

(51) Int. Cl. G06F 15/16

(52) U.S. Cl. 709/204

(57) ABSTRACT

A messaging architecture is disclosed which enables a single messaging application, handling non-transport specific attributes and operations, to manipulate any commonly known message type (such as fax, e-mail, pager, SMS, voice mail) using dynamically loadable plug-ins which contribute the ability to handle all transport specific attributes and operations. This architecture results in a single in-box being presented to a user for browsing all incoming messages, irrespective of message type.

### CROSS-REFERENCE TO RELATED APPLICATIONS

This application is a continuation of U.S. application Ser. No. 09/673,161, filed Oct. 11, 2000, which is the U.S. national stage of International Application No. PCT/GB00/00385, filed Feb. 9, 2000, which is based on and claims priority to Great Britain Application No. 9903032.2, filed Feb. 11, 1999, the contents of which are fully incorporated herein by reference.

### FIELD OF THE INVENTION

This invention relates to a messaging architecture, and particularly to an architecture which can manipulate electronically generated messages such as e-mail, fax, video, pager, SMS and voice mail messages.

### DESCRIPTION OF THE PRIOR ART

E-mail messaging applications are widely used in computers to allow e-mail to be created, displayed, sent and received. Examples of widely used PC e-mail messaging applications include Eudora and Microsoft Outlook. Messaging applications are also available for other message types, such as fax, pager, and SMS.

The conventional messaging approach requires a different application for each message type. Hence, a user set up to receive multiple message types will typically have to (a) learn a number of different messaging applications and/or (b) browse through the in-box folders of each of these applications to review all incoming messages. This can be both burdensome and time consuming. For example, some messaging applications can handle multiple message types; a conventional e-mail client can send and receive attachments which can be text documents, a voice file or a fax image. However, each of these different kinds of attachments have to be opened within a different application.

### STATEMENT OF THE PRESENT INVENTION

In accordance with a first aspect of the present invention, there is provided a method of manipulating electronically generated messages belonging to at least 2 of the following messages types: e-mail, fax, video, pager, SMS, voice mail; comprising the step of handling the electronically generated messages using a single messaging application.

Hence, the present invention is predicated on the insight that a messaging architecture comprising just a single messaging application can be constructed which can create, edit, display, send, receive, copy, move, delete and print (the generic term ‘manipulate’ will be used to refer to any of these acts, or combinations of these acts) the full range of current and likely future message types (e-mail, fax, video, pager, SMS and voice mail). The term ‘messages’ covers not only messages which are discrete units of information but also continuous information streams—i.e. streamed messages. It extends to information in any media format, including for example music files and video clips. The present invention may be used in wireless information devices, smart phones, communicators and other handheld communications devices. It may also be used in other non-handheld environments, for example in the servers powering universal messaging web sites. All such hardware implementations are generically referred to as electronic communications apparatus.

This leads to considerable advantages over the prior art: the user only has to learn how to use a single application to deal with all incoming and outgoing messages; the user only has to browse a single application to see all received messages, irrespective of type (this feature is referred to as a ‘universal in-box’); a single messaging application is likely to be more compact than a suite of messaging applications; and integration with other applications (for example, a word processor which can implement features like ‘Send As’—a feature which enables a user to select the type of message to be sent, e.g. fax, e-mail etc.) is simpler since the other applications only need to integrate with a single messaging application rather than many.

In one embodiment, the single messaging application handles certain attributes of messages which are shared by all supported message types and applies or invokes certain operations to the attributes of the messages which are applicable to all supported message types. Hence, the messaging application itself may be constrained to handle ‘generic’ attributes and apply or invoke ‘generic’ operations, where the term ‘generic’ means applicable across a very broad range of message types, including e-mail, fax, video, pager, SMS and voice mail. The generic attributes may include subject/description, date, size, message type, body text, originator, first recipient (some message types may define multiple recipients and different recipient classes but these are not known to the core application), priority, and a ‘flag’ indicating whether the message has attachments. Hence, the content of these attributes can all be displayed by the messaging application, even though they might originate from a very broad range of different messaging types and applications within types. The generic operations which the messaging application is constrained to apply or invoke are ‘manipulating’, namely creating, editing, displaying, sending and receiving, copying and moving (both of which are defined to differentiate local and remote operations, distinguishing CopyFromLocal from CopyFromRemote, CopyToLocal and CopyToRemote), deleting and printing.

All transport specific attributes and operations (i.e. those attributes and operations specific to the fax message type, or the e-mail message type, etc.) are in one embodiment handled by components, known as MTMs (Message Type Modules) which are entirely separate from the messaging application but which can be invoked by the messaging application as and when needed. Invoking code as and when needed is far more efficient than having to load the entire suite of code relevant to all message types.

Handling generic and transport specific parts of messages separately also leads to many advantages. For example, the architecture facilitates an implementation of the ‘universal in-box’ feature. The architecture can also be readily expanded to support any new message type merely by deploying a suitable new MTM for that new message type. Preferably, that is achieved using dynamically linked code, although it can also be achieved using statically linked code (the disadvantage of statically linked code is that new message types can be covered only by producing and distributing a new version of the application). The manner in which new MTMs must be designed is relatively unconstrained by the requirements of the messaging application itself, giving developers of MTMs greater design freedom. Finally, an application implementing a function (such as ‘Send As’) requiring integration with a messaging application does not need to know anything about the various message types that are available since it need deal only with generic parts of a message; forcing the application (for example, a word processor) to possess transport specific knowledge would prevent ‘Send As’ from being extensible as new message types are installed.

Alternative approaches to implementing a single, core messaging application capable of handling many message types include (a) pushing all message data into the specific part and (b) forcing the core messaging application to know the specific data for every message type. Whilst within the scope of the present invention, these approaches have several disadvantages. The first approach would mean that every new message type could behave perfectly with its data but would severely restrict the functionality available from the messaging application itself. The second approach would mean that the set of supported message types available in the application could not be extended without recompilation of the messaging application.

The messaging application may interface with one or more databases with loadable software code modules (sometimes referred to as DLLs—Dynamic Linked Libraries) relating to message type specific attributes and/or operations. A DLL is computer code which is (a) loaded into a program as required, rather than being pre-loaded, or (b) code which is linked on demand rather than being prelinked, or (c) code which is dynamically linked rather than statically linked, or (d) code which uses late binding rather than early binding. The term DLL is not used in this specification to refer to a DLL from any one vendor. The ability to manipulate new messaging types may then be dynamically added to a system whilst the system is fully operational (i.e. without the need for re-compilation) by adding the new loadable software code modules appropriate for the new message types to one or more databases.

As an example, transport specific elements of facsimile messages are in a preferred embodiment handled by a facsimile MTM (Message Type Module), whilst all generic parts are also handled by the messaging application. So if a high resolution fax is received, the messaging application itself has no ability to know or possess any interest in whether the message is high resolution or not. Instead, the facsimile MTM informs the messaging application which type of message the particular MTM handles (i.e. the facsimile type). The messaging application can interface through an API with a database of different message types and DLLs which can manipulate message data: this database is an example of what is called a Registry; in the detailed description which follows, it is the Registry called the UI Data Registry. Hence, the Registry loads up the DLL code to enable the messaging application to handle incoming facsimile messages appropriately. The facsimile MTM in effect populates the generic attributes in the messaging application (i.e. subject/description, date, size, message type, originator, recipient). Body text is also a generic field but is not used by received facsimile messages, for which the received data is effectively an image rather than text. The messaging application then simply displays the data in the generic attributes fields.

Each MTM is itself made up of a number (typically 5) of DLLs. Each of these DLLs fulfils a specific role: provision of text and numeric data for menus in the core application (this allows message type-specific behaviour to be launched from the messaging application); the UI required for the edit and display of messages; an interface layer between the UI and the message store; bridging code to interface between the internal storage of the message data and the standard protocol formats required for the message type; each MTM typically also utilities a DLL that can be used by one or more of the other DLLs.

The use of DLLs for message type specific behaviour means that the messaging application itself does not have to include the code required for detailed UI, data storage or protocol format aspects of each messaging type. As noted earlier, this builds in the ability for different vendors to produce different UIs, giving product differentiation, and also means that new messaging types can be dynamically added to a system whilst the system is fully operational by adding new DLLs to the Registry.

In a second aspect, there is provided a software program for manipulating messages of a given type, comprising one or more loadable software code modules capable of interfacing with a single messaging application, the loadable software code modules relating to message type specific attributes and/or operations and the single messaging application being operable to manipulate electronically generated messages belonging to at least 2 of the following messages types: e-mail, fax, video, pager, SMS and voice mail.

Such a software program may be a dynamically loadable plug-in to the messaging application. Each loadable software code module may be individually capable of enabling the execution of one or more tasks from the following list of tasks:
(a) Reporting to the messaging application the functional capabilities of one or more loadable software code modules;
(b) Supplying text for on-screen menus;
(c) Creating, and/or editing and/or displaying messages;
(d) Converting messages to be sent by the application to a protocol and format required by an external recipient and the conversion of messages received by the application to a protocol and format required by the messaging application.

The loadable software code modules are typically implemented as object oriented code which create real objects to execute tasks.

In a third aspect, there is provided a computer operating system comprising a single messaging application operable to handle at least 2 of the following messages types: e-mail, fax, video, pager, SMS, and voice mail. The operating system is preferably operable to participate in the performance of the first aspect of the method when used in conjunction with a software program defined in the second aspect.

In a forth aspect, there is provided a method of manipulating electronically generated messages using a messaging application, wherein the messaging application interfaces with several databases, each with loadable software code modules, each database individually enabling the execution of one or more tasks from the following list of tasks:
(a) Reporting to the messaging application the functional capabilities of one or more loadable software code modules;
(b) Supplying text for on-screen menus;
(c) Creating, and/or editing and/or displaying messages;
(d) Converting messages to be sent by the application to a protocol and format required by an external recipient and the conversion of messages received by the application to a protocol and format required by the messaging application.

This architectural approach, which can be referred to as multi-tiering, leads to several advantages, namely (1) the loading of an MTM component to deal with message-type-specific behaviour as required by the core application can be restricted to the functionality that is required at the time. For example, there is no need to load POP3 and SMTP protocol interface code while simply creating and editing an email message for later despatch from the device; conversely, when connected to a remote mailbox, the UI code for displaying an email message is not loaded. (2) Upgrades to the software can be provided in smaller components than would otherwise be the case. (3) The definition of strict APIs at each tier in the architecture allows for component development—a single component of an MTM can be developed in isolation with a relative guarantee that it will interoperate successfully with other components of the MTM.

In a fifth aspect, there is provided a computer system operable to perform the forth aspect of the invention when used in conjunction with the several databases defined in the forth aspect.

In a sixth aspect, there is provided electronic communications apparatus to perform any of the above inventive methods or programmed with any of the above inventive software.

### BRIEF DESCRIPTION OF THE DRAWING

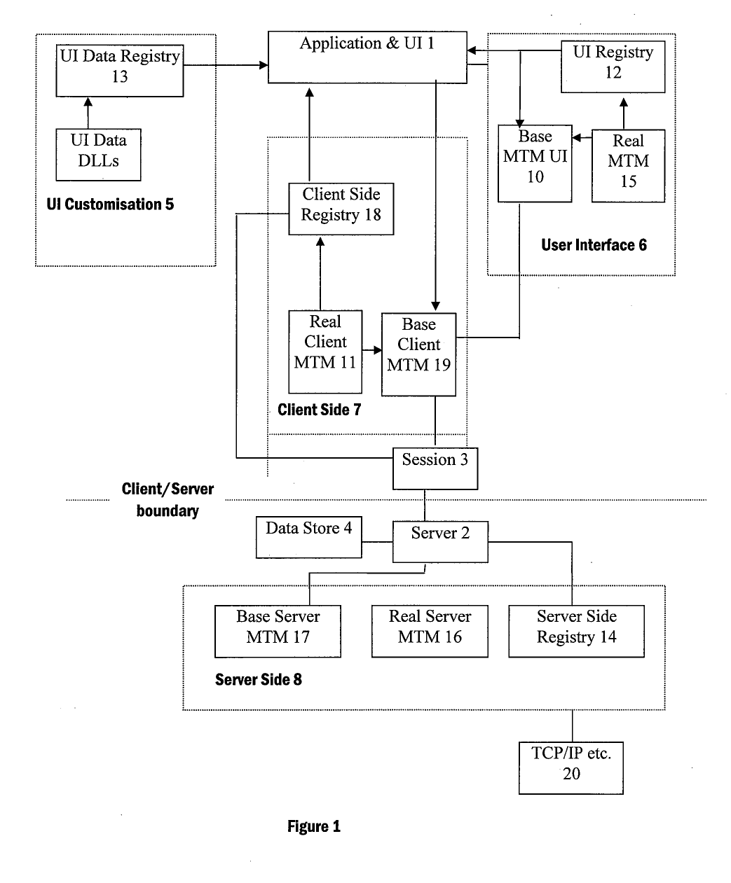

The invention will be described with reference to FIG. 1, which is a functional overview of the messaging architecture envisaged in an embodiment of the present invention.

### DETAILED DESCRIPTION

Major Components

The Messaging Architecture of the present invention is exemplified by the EPOC messaging architecture from Symbian Limited of the United Kingdom. The following discussion presumes some knowledge of object oriented software. For a detailed understanding of EPOC, a variety of public domain sources can be consulted, such as the WWW site www.epoc.com, and freely available software developers kits for EPOC from Symbian Limited.

The architecture consists of three significant components—the Message Server, which provides true client/server access to all message data, an Application Framework which allows compliant plug-in components to be invoked by a Core Application. This Core Application is the Messaging Application 1, and the functionality supplied by the plug-in components is the implementation of any messaging protocol.

There are seven major components indicated by the diagram, as follows:

The Messaging Application and its UI 1

The Message Server 2, Client Sessions 3 and Message Data Store 4

UI Customisation 5

User Interface 6

Client-side components 7

Server-side components 8

The term ‘Server’ is used to refer to components which provide multiple shared access to a scarce resource (in this case, message files, serial ports and comms. devices). All components will typically be implemented in software within a single device, such as a smart phone or communicator.

The term ‘Base’ is used in the normal object orientation sense to refer to a declaration of what functions can be performed; the term ‘Real’ is used, again in the normal object orientation sense, to refer to how those functions will be performed.

The last four of the components above comprise the set of registerable plug-in components for a given MTM (Message Type Module). Typically, a real MTM will also have a utilities component which the other components can use, but this does not need to be stored in a given MTM Registry (the database of DLLs associated with a given MTM) because of support for explicit linkage in EPOC. This ensures that all DLLs that an application or DLL requires are loaded at the same time as the application or DLL.

The Messaging Application

The core Messaging Application 1 within EPOC knows nothing about specific messaging protocols, and can only interact with generic APIs (Application Programming Interfaces). These generic, or base, APIs define functionality that must be provided by any plug-in components that are to be registered as MTMs. From the user's point of view, the core application is the entry point to all messaging functionality on the EPOC device. The application contains, for all message types, the Inbox, Outbox and all folder manipulation for message storage. The actual appearance of the Inbox and Outbox can be different for each different message type which is supported.

The Inbox is, from the user's perspective, the list of all messages recently received onto the user's device and not yet dealt with. The Application 1 creates this view by first creating a Session 3 on the Message Server 2—this allows the Application 1 to walk through the list of stored messages and display from each message the generic data that it stores. Drawing the Inbox in this way does not require the use of any message-type-specific data, and hence does not require the loading of any MTMs.

The Outbox and any local folder view are drawn in exactly the same way—since the user can only see generic data fields in those views (things like the message description or subject, date, size, priority and so on), the Application 1 does not need to invoke any type-specific functionality in the registered MTMs. The Inbox and Outbox are just special cases of folder views—views of the message store which group the messages together by their logical ‘location’, in which the concept of a folder is used to allow grouping of related messages together.

There is one exception to the rule of the Application 1 not needing to load any message type-specific functionality. This is the generation by the application of message type-specific menu items on the folder view. For example, the folder view always provides the options of creating a new message or receiving a fax. This functionality cannot be provided by the core Application 1 since it requires knowledge of individual message types. This leads us to the need for the UI Customisation 5 component, the first example of a registered MTM component.

MTM Registries

In each of the UI 6, Client Side 7 and Server Side 8 blocks of the application framework (as shown in the diagram), use of an implemented component is never direct. Every MTM component used by the core Application 1, for example, is only accessed through the base API, either the ‘Base MTM UI’ 10 API or the ‘Base Client MTM’ 11 API. The core Application 1 knows these APIs and knows what kind of behaviour to expect when it invokes a given function in a base API. However, it does not know exactly what will happen since this depends on the type of message that is being manipulated.

The core Application 1 has to know that the real action it is invoking is related to the real message that is being manipulated. For example, it would be meaningless and probably dangerous for the Application 1 to give an e-mail message to code designed to work on fax messages. The application framework, and in particular the registries (i.e. the UI Registry 12, the UI Data Registry 13 and the Server Side Registry 14), prevent this misalignment of function and data by associating every message with a type. All interactions with message objects require the application to supply a type ID—this is simply a number that has no meaning other than to ensure that the Application 1, the Registry (12, 13 or 14), the MTM component created by the Registry and the message object created by the MTM are all dealing with the same type. This check is made throughout the application framework to ensure that data is not being mishandled.

The general operation of a Registry (of any type) is to load a DLL which contains code that can manipulate message objects of a given type. All MTM components must satisfy the appropriate base class API for the level of the application framework at which the component is to operate. The core Application 1 (or the Message Server 2, in the case of server-side MTM components) only deals with this base API and so it is essential that the real implementation of an MTM is correct.

UI Customisation

Fundamental to the utility of the Messaging Application framework is the ability of a registered component to be able to report what it can and cannot do, to the application. This is used through the QueryCapability function in the base API.

For example, when the user accesses the ‘Create New Message’ menu item, the Application 1 must be able to determine which of the registered MTMs can actually define messages locally and then transmit them from the device. An example of a message type which supports 'sending’ is fax or email; Cell Broadcast Service (a GSM protocol which allows text delivery to all suitably-equipped handsets in a cell) is receive-only. Each time the core Application 1 needs to know a particular capability for each of the registered message types, which has a simple yes/no answer (e.g. ‘Can send messages’, ‘Can support attachments’) or which has a simple numeric answer (e.g. ‘Maximum message size’ or ‘Maximum number of attachments’), it invokes the UI Data Registry 13. This allows retrieval of the required data without having to load the entire MTM.

As indicated above, the UI Data component 13 of an MTM can also supply an entire menu command to the core Application 1. In this case, the registered MTM supplies a text string (for the menu) and a function number to the Application 1. When the user selects the relevant menu item from the folder view, the Application 1 calls back to the InvokeFunction API of the relevant MTM, passing back the function number that was originally supplied with the menu text string. At this point, the Application 1 has interacted not only with the UI Data Registry 13, but also with the User Interface Registry 12, and has loaded up the UI component for the appropriate MTM.

User Interface

When the Application 1 is required to display and/or edit a message of a known type, it must first ensure that it has an editor/viewer object from the correct MTM. This is done through the UI Registry 12. The application gives the Registry the ID (simply a number which has no meaning to the application), and the UI Registry 12 uses it to look up which DLL should be loaded. This look-up is done through a database of installed message types—the registration of a message type involves writing (among other things) its human-readable name and definition of which DLL contains the appropriate code to achieve the message type specific behaviour that is required.

The Base MTM UI 10 API provides generic functions such as ‘Edit’ to the core Application 1. The Real MTM 15 object includes all the data structures and code required to manipulate e-mail.

It is simply by invoking these functions that the Application 1 launches the editor and viewer objects for each message type. Implementation specific features—such as whether the message can have attachments, or whether a spell checker is available for the message body—are invisible to the core Application 1, and are only known within the Real MTM 15 on the diagram.

The UI components of an MTM know about the message type-specific data storage as well as the generic parts of the message. This knowledge is usually encapsulated in a few classes that are stored in the utility DLL mentioned earlier—this allows the client-side and server-side components within that MTM to access the same classes. This sharing of code is particularly important for storing and restoring message data—only one class should be aware of the storage format for an email, for example, and that class should be used wherever it is necessary to save or retrieve emails.

Client-side MTM Components

Much of the functionality that the UI components of an MTM supply can also be accessed through the client-side MTM component (i.e. Client Side Registry 18, Real Client MTM 11 and Base Client MTM 19). The significant difference is that nothing that the client-side components supply requires any user interface. This allows any external application to hook up to the messaging architecture and interact with message-type-specific data. The core messaging Application 1 is capable of using client-side components as well as UI components, but in practice the UI components supply sufficient functionality that this is not necessary.

The greater use of the client-side components will be in automation of messaging processes, where user interaction is not required. Examples of this are typically found in smart messaging, in which the EPOC device receives an incoming SMS message (the SMS MTM has been written so that it is always ready to receive a message without user intervention) and handles the data automatically and perhaps immediately. The data could be an Agenda entry, an electronic Business Card from a new contact or perhaps settings data for a new internet account. Client-side processes looking out for new messages of a particular type(s) will need to load the relevant client-side MTM to be able to interact with the data correctly.

Server-Side MTM Components

Being able to handle message data in a common fashion within the Application 1 is only half the true requirement for a single messaging application that supports a Universal Inbox. It is also essential that message data can be converted to and from the formats that are used in the ‘real world’. This is the job of the Server-side components of the MTMs (i.e. the Server Side Registry 14, Real Server MTM 16 and Base Server MTM 17).

For example, an incoming email will generally consist of a header and a number of body parts, all defined in normal ASCII text. An incoming SMS is formed in compliance with the relevant ETSI spec, and is a tightly-packed frame of 256 bytes of human unreadable binary data—it has to be decoded and converted before any sense can be made of it by a person.

Since every message type requires its own user interface and storage code to cater for attributes that are not found in other message types, and since every message type has different protocol and formatting requirements, it follows that the bridging software (between the internal storage of a message and the appearance it must have top be recognised off the device) must also be provided in a message-type-specific fashion to be loaded as appropriate.

An Example: Creating and Sending an E-mail

First, the messaging Application 1 interfaces with the UI Data Registry 13 using an appropriate API; the messaging Application 1 then issues a QueryCapability to all of the registered MTMs to determine which ones can send messages. It then creates a cached list of all registered MTMS which are capable of sending a message of any type.

The UI Data Registry 13 passes to the Application 1 the text string for the human readable name of the message types capable of sending messages for use in creating the menu for the inbox (or other folder view). Hence, for each message type that can send messages, the human-readable name is displayed on the side menu when the user selects ‘Create new’ on the folder view menu.

The Application 1 then takes the Message type ID appropriate to the name chosen by the user (in this case, ‘e-mail’), and submits it to the UI Registry 12, requesting a component that can handle the generic and transport specific data of e-mail. (The messaging application could also submit the e-mail Message type ID to the Client Side Registry and the Client Side Registry could then undertake all the steps, described below, which are taken by the UI Registry.) The UI Registry 12 then creates a real e-mail object: the Real MTM 15 shown in the figure. The Real MTM 15 includes all the data structures and code required to manipulate e-mail. The messaging application then transacts with the generic message APIs in the Base MTM UI 10.

The UI Registry 12 loads the DLL which has been registered as containing the Email editor, and returns to the application a pointer to a function which can be used to create an Email editor object. The core Application 1 knows that all editors, regardless of type, supply a function ‘Create’ which will create a new message and display it to the user for definition. The Application 1 is unaware of the actual type of the message (it only had a number which it got from the menu and passed direct to the UI Registry 12), but the user sees a real email editor with all the fields he expects to see. When the user starts entering a new message, the Server 2 is asked to create a new Data Store 4 to hold the message. The Server 2 tells the Real Client MTM 11 the address of the Data Store 4 and how to write to it. When the user is satisfied with the email, he selects ‘Close’ on the editor's menu (note that this is within message-type-specific code) and the email editor saves all parts of the message—the generic fields, the email-specific data and the body text.

To send a message, the user browses the Outbox and selects the ‘Send’ function. If all messages are e-mails, then the messaging Application 1 submits the e-mail Message type ID to the Client Side Registry 18. The Client Side Registry 18 then creates the Real Client MTM 11 object: that opens up the correct data store for the message and performs any preparation required (e.g. checking that any attachments are still in existence). The Application 1 then creates a Session 3 to tell the Server 2 that it wants to send a message, which has been given a unique identifying number. The Server checks the Message type ID and loads up the correct Real Server MTM 16. The Base Server MTM 17 includes the operation ‘Send’; once activated, the Real Server MTM 16 opens the message and works out the correct support components, such as TCP/IP 20. It then performs the required encoding (typically Base 64) of any attachments, and then transmits the message. After transmission, it closes the Data Store 4 file, tags it as successfully sent and then tells the Session 3 that the message has been sent.

1. A method of manipulating electronically generated messages belonging to at least two of the following message types: e-mail, fax, video, pager, SMS, voice mail; comprising handling the electronically generated messages using a single messaging application, wherein said single messaging application is run by the same device on which the messages are displayed.

2. The method of manipulating electronically generated messages of claim 1 wherein the single messaging application handles attributes of messages, these attributes being shared by all of the message types.

3. The method of manipulating electronically generated messages of claim 2 wherein the single messaging application invokes or applies operations to the attributes of the messages, these operations being applicable to all of the messages types which are capable of being manipulated by the single messaging application.

4. The method of manipulating electronically generated messages of claim 3 wherein the single messaging application interfaces with one or more databases of loadable software code modules relating to at least one message type specific attributes and operations.

5. The method of manipulating electronically generated messages of claim 4 wherein a new messaging type can be dynamically added to a system whilst the system is fully operational by adding new loadable software code modules to one or more databases.

6. The method of manipulating electronically generated messages of claim 3 wherein all user interface code is accessed through a database using loadable software code modules.

7. An electronic communications device comprising:
a user interface able to display electronically generated messages to an end-user; and
a single messaging application running locally on the device, the messaging application programmed to handle attributes shared by electronically generated messages of several different messages types; wherein:
(i) the different message types include two or more of: e-mail, fax, video, pager, SMS (short message service), voice mail, music files, video clips; and
(ii) the attributes are generic attributes shared by the different message types and are selected from the list: subject/description, date, size, message type, body text, originator, first recipient, priority, attachment flag.

8. The device of claim 7 wherein said user interface can display all incoming messages of any of the different message types in a single in-box window.

9. The device of claim 7 in which the single messaging application is further programmed to enable an end-user to manipulate the messages of different messages types from within the single mailbox window, the manipulation comprising an act selected from the list: create, edit, display, send, receive, copy, move, delete, and print, or a combination thereof.

10. The device of claim 7 in which the message types are selected from the following list: e-mail, fax, video, pager, SMS (short message service), voice mail, music files, video clips and any message type that has one or more generic attributes.

11. The device of claim 7 wherein the single messaging application is further programmed to invokes or apply certain generic operations to the generic attributes of the messages, such as edit, display, send, receive, copy, move, delete, print.

12. The device of claim 11 wherein a further application running on the device invokes or applies only these generic operations and not any operations that are specific to a given message type.

13. The device of claim 7 wherein, if the messaging application is unable to handle an attribute that is specific to a message type, then it invokes a software code module relating to that attribute, as and when needed.

14. The device of claim 13 wherein a new message type can be dynamically added to a system whilst the system is fully operational and without having to be re-started by adding new loadable software code modules.

15. The device of claim 14 wherein each loadable software code module is individually capable of enabling the execution of one or more tasks from the following list of tasks:
(a) Reporting to the messaging application the functional capabilities of one or more loadable software code modules;
(b) Supplying text for on-screen menus;
(c) Creating, and/or editing and/or displaying messages;
(d) Converting messages to be sent by the application to a protocol and format required by an external recipient and the conversion of messages received by the application to a protocol and format required by the messaging application.

16. The device of claim 15 wherein the loadable software code is object oriented code which creates real objects to execute a task.

17. The device of claim 7 wherein, if the messaging application is unable to handle an operation that is specific to a message type, then it invokes a software code module relating to that operation, as and when needed.

18. The device of claim 17 wherein a new message type can be dynamically added to a system whilst the system is fully operational and without having to be re-started by adding new loadable software code modules.

19. The device of claim 18 wherein each loadable software code module is individually capable of enabling the execution of one or more tasks from the following list of tasks:
(a) Reporting to the messaging application the functional capabilities of one or more loadable software code modules;
(b) Supplying text for on-screen menus;
(c) Creating, and/or editing and/or displaying messages;
(d) Converting messages to be sent by the application to a protocol and format required by an external recipient and the conversion of messages received by the application to a protocol and format required by the messaging application.

20. The device of claim 19 wherein the loadable software code is object oriented code which creates real objects to execute a task.

21. The device of claim 1, being a handheld wireless communications device.
